(19) United States
(12) Patent Application Publication
(10) Pub. No.: US 2008/0247783 A1
(43) Pub. Date: Oct. 9, 2008

(54) IMAGE FORMING APPARATUS, IMAGE FORMING METHOD AND DEVELOPING AGENT

(75) Inventors: Yousuke Imamura, Mishima-shi (JP); Hiroshi Kawaguchi, Ashigarakami-gun (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/696,488

(22) Filed: Apr. 4, 2007

(51) Int. Cl. G03G 15/06; G03G 21/00; G03G 9/00

(52) U.S. Cl. 399/222; 430/109.4; 430/110.3; 430/123.51; 399/350

(57) ABSTRACT

In an image forming apparatus containing a developing device containing a toner housed therein and feeding the toner onto a photoreceptor to form a toner image, and a cleaning blade removing the toner remaining on the photoreceptor after transferring the toner image formed on the photoreceptor to a transfer medium, a toner having a particle diameter of from 5 to 8 μm and a degree of circularity of from 0.925 to 0.965 and having a lubricant added to a surface thereof in an amount of from 0.01 to 0.125 wt % is used, and the cleaning blade has a hardness of from 60 to 80, a 300% modulus of from 100 to 420 kg/cm², a tear strength of from 35 to 120 kg/cm, a repulsive elasticity at 10° C. of from 10 to 50%, and a repulsive elasticity at 40° C. of from 40 to 80%.

### BACKGROUND OF THE INVENTION

1. Field of the Invention

The present invention relates to an image forming apparatus and an image forming method that are used for forming an image by an electrophotographic system, for example, with a duplicator and a printer.

2. Description of the Related Art

In an image forming apparatus using an electrophotographic system, in general, a toner, which contains colored particles, is conveyed with a conveying medium, such as a photoreceptor and an intermediate transfer medium, e.g., a transfer belt, and adhered to a desired position on a transfer medium, such as paper. The toner is then fixed with a heat roller or the like on the transfer medium, so as to form an image on the transfer medium.

At this time, the toner that has not transferred remains on the photoreceptor after transferring the image onto the transfer medium, and the remaining toner is removed by a cleaning step using a cleaning blade or the like.

In recent years, there is such a tendency that the toner particle diameter is decreased for forming a high definition image. However, the transfer property is deteriorated when the toner particle diameter is decreased. High transfer property can be obtained by improving the toner particles in degree of circularity, but the cleaning property on the photoreceptor is impaired by improving the degree of circularity to cause cleaning failure, which brings about image failure due to filming on the photoreceptor. By increasing the toner particle diameter and decreasing the degree of circularity, the cleaning property is improved, but the image quality is deteriorated.

When the cleaning property is to be ensured by controlling the conditions for the cleaning blade, for example, by increasing the hardness of the cleaning blade, there is such a problem that the photoreceptor is deteriorated in service life due to wear of the layers.

JP-A-2000-10313 proposes such a measure that a photoreceptor is improved in slipping property on the surface thereof, and a cleaning blade that has a hardness within a prescribed range with the pressure thereof being decreased, whereby the cleaning property is improved. However, it has been difficult to prevent a photoreceptor from suffering wear and release of layers and to prevent a cleaning blade from suffering deterioration in service life due to wear and cracking, so as to improve the cleaning property, while maintaining high image quality and high transferring property, even in, for example, a duplicator using a photoreceptor having a diameter of 50 or less.

### SUMMARY OF THE INVENTION

An object of the invention is to provide an image forming apparatus and an image forming method that are capable of suppressing a photoreceptor and a cleaning blade from being deteriorated in service life to realize high cleaning property, high image quality and high transfer property.

According to one aspect of the invention, such an image forming apparatus is provided that contains a developing device containing a toner housed therein and feeding the toner onto a photoreceptor to form a toner image, and a cleaning blade removing the toner remaining on the photoreceptor after transferring the toner image formed on the photoreceptor to a transfer medium, the toner having a particle diameter of from 5 to 8 μm and a degree of circularity of from 0.925 to 0.965 and having a lubricant added to a surface thereof in an amount of from 0.01 to 0.125 wt %, and the cleaning blade having a hardness of from 60 to 80, a 300% modulus of from 100 to 420 kg/cm², a tear strength of from 35 to 120 kg/cm, a repulsive elasticity at 10° C. of from 10 to 50%, and a repulsive elasticity at 40° C. of from 40 to 80%.

According to another aspect of the invention, such an image forming method is provided that includes feeding a toner having a particle diameter of from 5 to 8 μm and a degree of circularity of from 0.925 to 0.965 and having a lubricant added to a surface thereof in an amount of from 0.01 to 0.125 wt % onto a photoreceptor to form a toner image; transferring the toner image on the photoreceptor to a transfer medium; and removing the toner remaining untransferred on the photoreceptor with a cleaning blade having a hardness of from 60 to 80, a 300% modulus of from 100 to 420 kg/cm², a tear strength of from 35 to 120 kg/cm, a repulsive elasticity at 10° C. of from 10 to 50%, and a repulsive elasticity at 40° C. of from 40 to 80%.

According to still another aspect of the invention, such a developing agent is provided that is used in an image forming apparatus containing a developing device containing a toner housed therein and feeding the toner onto a photoreceptor to form a toner image, and a cleaning blade removing the toner remaining on the photoreceptor after transferring the toner image formed on the photoreceptor to a transfer medium, and the cleaning blade having a hardness of from 60 to 80, a 300% modulus of from 100 to 420 kg/cm², a tear strength of from 35 to 120 kg/cm, a repulsive elasticity at 10° C. of from 10 to 50%, and a repulsive elasticity at 40° C. of from 40 to 80%, and the developing agent containing a toner having a particle diameter of from 5 to 8 μm and a degree of circularity of from 0.925 to 0.965 and having a lubricant added to a surface thereof in an amount of from 0.01 to 0.125 wt %.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE DRAWINGS

FIG. 1 is a conceptional view showing an image forming apparatus for a two-component developing process according to one embodiment of the invention.

FIG. 2 is a table showing the toner characteristics, the cleaning blade characteristics and the evaluation results in Examples and Comparative Examples of the invention.

### DETAILED DESCRIPTION OF THE EMBODIMENTS

The image forming apparatus according to one aspect of the invention contains a developing device containing a toner housed therein and feeding the toner onto a photoreceptor to form a toner image, and a cleaning blade removing the toner remaining on the photoreceptor after transferring the toner image formed on the photoreceptor to a transfer medium, the toner has a particle diameter of from 5 to 8 μm and a degree of circularity of from 0.925 to 0.965 and has a lubricant added to a surface thereof in an amount of from 0.01 to 0.125 wt %, and the cleaning blade has a hardness of from 60 to 80, a 300% modulus of from 100 to 420 kg/cm², a tear strength of from 35 to 120 kg/cm, a repulsive elasticity at 10° C. of from 10 to 50%, and a repulsive elasticity at 40° C. of from 40 to 80%.

The image forming method according to another aspect of the invention includes feeding a toner having a particle diameter of from 5 to 8 μm and a degree of circularity of from 0.925 to 0.965 and having a lubricant added to a surface thereof in an amount of from 0.01 to 0.125 wt % onto a photoreceptor to form a toner image; transferring the toner image on the photoreceptor to a transfer medium; and removing the toner remaining untransferred on the photoreceptor with a cleaning blade having a hardness of from 60 to 80, a 300% modulus of from 100 to 420 kg/cm², a tear strength of from 35 to 120 kg/cm, a repulsive elasticity at 10° C. of from 10 to 50%, and a repulsive elasticity at 40° C. of from 40 to 80%.

The developing agent according to still another aspect of the invention is used in an image forming apparatus containing a developing device containing a toner housed therein and feeding the toner onto a photoreceptor to form a toner image, and a cleaning blade removing the toner remaining on the photoreceptor after transferring the toner image formed on the photoreceptor to a transfer medium, the cleaning blade has a hardness of from 60 to 80, a 300% modulus of from 100 to 420 kg/cm², a tear strength of from 35 to 120 kg/cm, a repulsive elasticity at 10° C. of from 10 to 50%, and a repulsive elasticity at 40° C. of from 40 to 80%, and the developing agent contains a toner having a particle diameter of from 5 to 8 μm and a degree of circularity of from 0.925 to 0.965 and has a lubricant added to a surface thereof in an amount of from 0.01 to 0.125 wt %.

The toner particles housed in the developing device and fed onto the photoreceptor contain at least a binder resin, such as a polyester resin and a styrene-acrylate resin, and a colorant, such as a known pigment or dye, e.g., carbon black, a condensed polycyclic pigment, an azo pigment, a phthalocyanine pigment and an inorganic pigment. The toner particles may further contain a releasing agent, such as wax, and a charge controlling agent, depending on necessity. Furthermore, the toner particles may contain an external additive, such as inorganic fine particles, e.g., silica, alumina, titanium oxide, and organic fine particles, for improving the flowability.

The toner particles necessarily have a volume average particle diameter d of from 5 to 8 μm. In the case where it is less than 5 μm, good transferring property cannot be obtained, and in the case where it is more than 8 μm, reproducibility of a high definition image is deteriorated. The volume average particle diameter is more preferably from 6 to 7 μm.

The toner particles necessarily have a degree of circularity of from 0.925 to 0.965. In the case where the degree of circularity is less than 0.925, good transferring property cannot be obtained, and in the case where it is more than 0.965, the cleaning property is lowered to cause image failure due to filming on the photoreceptor. The degree of circularity is more preferably from 0.940 to 0.950.

The toner particles necessarily have a lubricant added to a surface thereof in an amount of from 0.01 to 0.125 wt %. The lubricant is a material having lubricating property, such as a metallic soap, e.g., zinc stearate, and fluorine resin powder. In the case where the addition amount of the lubricant is less than 0.01 wt %, the photoreceptor is scraped due to large friction between the cleaning blade and the photoreceptor, which brings about image failure and occurrence of abnormal noise due to warpage of the blade. In the case where it exceeds 0.125 wt %, friction between the photoreceptor and the cleaning blade is considerably reduced to lower the cleaning property, which brings about image failure due to filming on the photoreceptor. The addition amount is more preferably from 0.03 to 0.10.

The toner particles are formed, for example, by the following manner. In 100 wt % by weight of the binder resin, from 1 to 10 wt % of a colorant, and depending on necessity, a releasing agent, a charge controlling agent and the like, are mixed and dispersed by using a ball mill, a V-blender or the like, and they are heated, melted and kneaded by using a pressure kneader, a roll or the like, and then finely pulverized by using a hammer mill, a jet mill or the like. The toner particles can also be formed by a chemical method, such as a polymerization method, instead of the pulverization method.

The toner particles are classified into an intended particle size by a wind classification method or the like, and then mixed with a lubricant and, depending on necessity, an external additive and the like with a high-speed flow mixer or the like, so as to obtain toner particles having an intended formulation. The toner particles may be controlled in degree of circularity with a surfusing system or the like, depending on necessity before or after the addition of the lubricant and the like.

In the case of two-component development, the toner particles are further mixed with a magnetic carrier for use as a two-component developing agent. The magnetic carrier is constituted by resin particles having mixed therein magnetic powder, such as ferrite, magnetite and iron oxide, or particles containing magnetic powder having a resin coating on at least a part of the surface thereof.

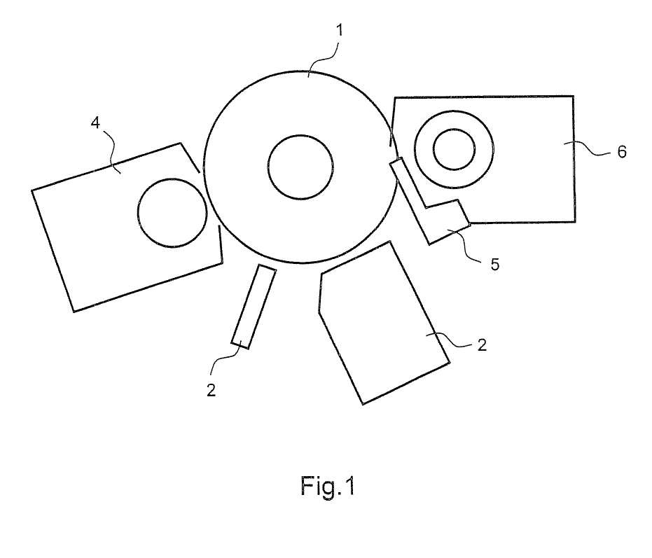

The toner particles are put, for example, in an image forming apparatus of a two-component development process shown in FIG. 1. As shown in the figure, there are disposed a photoreceptor 1, a charging device 2 for charging it, an exposing device 3 for forming an electrostatic latent image, a developing device 4 housing a developing agent and feeding the toner particles to the electrostatic latent image, and a cleaner unit 6 equipped with a cleaning blade 5 removing the toner remaining untransferred.

As the photoreceptor, a known photoreceptor, such as a positively charged or negatively charged OPC (organic photoconductor) and amorphous silicon, is used. In the photoreceptor, a charge generating layer, a charge transporting layer and a protective layer may be accumulated on the surface, or a layer having functions of plural layers among these layers may be formed thereon. The diameter thereof is preferably 50 mm or less for miniaturizing the apparatus. As the exposing device, a known measure, such as laser and LED, may be used.

An image is formed on a transfer medium, such as paper, by using the image forming apparatus in the following manner.

The photoreceptor is uniformly charged to an intended potential with the charging device. The photoreceptor is exposed with the exposing device 3 to form an electrostatic latent image on the photoreceptor 1. The charged toner particles are fed and adhered with the developing device 4 to the electrostatic latent image on the photoreceptor 1 to form a toner image. The toner image thus formed is transferred to the transfer medium, such as paper, by using a known transferring means (which is not shown in the figure), through an intermediate transfer medium (which is not shown in the figure), such as a belt and a roller, or directly, and then fixed with a known heat-pressure fixing mechanism (which is not shown in the figure), such as a heat roller, followed by discharging outside the apparatus. After transferring the toner image, the toner remaining untransferred on the photoreceptor 1 is removed with the cleaning blade 5 equipped in the cleaner unit 6, and the electrostatic latent image on the photoreceptor 1 is erased with a destaticizing lamp (which is not shown in the figure).

The cleaning blade used for removing the toner remaining untransferred necessarily has a hardness of from 60 to 80 measured according to the blade hardness measuring method (JIS K6301 Type A). In the case where the hardness is less than 60, the cleaning property is lowered to cause image failure due to filming on the photoreceptor. In the case it exceeds 80, large friction occurs between the cleaning blade and the photoreceptor, which brings about occurrence of abnormal noise due to warpage of the blade. The hardness is more preferably from 65 to 75.

The 300% modulus measured according to the 300% modulus measuring method (JIS K6251) is necessarily from 100 to 420 kg/cm². In the case where the 300% modulus is less than 100 kg/cm², the cleaning property is lowered to cause image failure due to filming on the photoreceptor. In the case where it exceeds 420 kg/cm², large friction occurs between the cleaning blade and the photoreceptor, which brings about occurrence of abnormal noise due to warpage of the blade. The 300% module is more preferably from 150 to 300 kg/cm².

The tear strength measured according to the tear strength measuring method (JIS K6252) is necessarily from 35 to 120 kg/cm. In the case where the tear strength is less than 35 kg/cm, the cleaning property is lowered to cause image failure due to filming on the photoreceptor. In the case where it exceeds 120 kg/cm, large friction occurs between the cleaning blade and the photoreceptor, which brings about occurrence of abnormal noise due to warpage of the blade. The tear strength is more preferably from 50 to 70 kg/cm.

The repulsive elasticity at 10° C. measured according to the repulsive elasticity measuring method (JIS K6255) is necessarily from 10 to 50%. In the case where the repulsive elasticity at 10° C. is less than 10%, the cleaning property is lowered to cause image failure due to filming on the photoreceptor. In the case where it exceeds 50%, large friction occurs between the cleaning blade and the photoreceptor under a low temperature environment, which brings about occurrence of abnormal noise due to warpage of the blade. The repulsive elasticity at 10° C. is more preferably from 20 to 40 kg/cm.

The repulsive elasticity at 40° C. measured according to the repulsive elasticity measuring method (JIS K6255) is necessarily from 40 to 80%. In the case where the repulsive elasticity at 40° C. is less than 40%, the cleaning property is lowered under a high temperature environment to cause image failure due to filming on the photoreceptor. In the case where the repulsive elasticity at 40° C. exceeds 80%, large friction occurs between the cleaning blade and the photoreceptor, which brings about occurrence of abnormal noise due to warpage of the blade. The repulsive elasticity at 40° C. is more preferably from 60 to 70 kg/cm.

The invention will be described in detail below with reference to examples.

In Examples and Comparative Examples, the average particle diameter of the toner particles was measured by using a particle size distribution measuring apparatus (Beckman Coulter Counter Multisizer 3).

In the measurement of the degree of circularity of the toner particles, a flow particle image analyzer FPIA-3000, produced by Sysmex Corp. was used, and the degree of circularity (which was 1 for a true sphere) was obtained as D1/D2, wherein D1 represents the circumferential length calculated from the diameter of the true circle having the area equivalent to the projected area of the particle, and D2 represents the circumferential length of the projected particle.

### EXAMPLE 1

### (Formation of Toner Particles)

92.5 parts by weight of a polyester resin (produced by Kao Corp.), 5 parts by weight of carbon black (MA-100, produced by Mitsubishi Kasei Co., Ltd.), 0.5 part by weight of a charge controlling agent and low molecular weight polypropylene wax (Viscol 660P, produced by Sanyo Chemical Industries, Ltd.) were melted and kneaded under heating. The mixture was cooled, and then pulverized and classified to form toner mother particles having an average particle diameter of 6.5 μm.

The toner mother particles thus formed were subjected to a surfusing treatment to obtain a degree of circularity of 0.945. To 100 parts by weight of the toner mother particles, 0.5 part by weight of hydrophobic silica (R-972, produced by Nippon Aerosil Co., Ltd.) and 0.5 part by weight of titanium oxide as external additives, and 0.050 part by weight of a metallic soap (zinc stearate) as a lubricant were added and mixed by using a Henschel mixer (Mitsui Miike Machinery Co., Ltd.) to form toner particles. In the conditions for mixing, the peripheral velocity of the points of blades was 20 m/s, the period of time of rotating the blades was 5 minutes, and the ration of the distance between the point of deflector and the wall of the mixing bath to the distance between the axis of the deflector and the wall of the mixing bath was ½.

The toner particles thus formed were mixed with a carrier containing ferrite particles having a particle size distribution of 150-300 mesh coated with a silicone resin at a weigh ratio of 7/93 to prepare a two-component developing agent.

The developing agent thus prepared to have the formulation was put in an image forming apparatus shown in FIG. 1 using a cleaning blade having a blade hardness of 60, a 300% modulus of 100 kg/cm², a tear strength of 35 kg/cm, a repulsive elasticity at 10° C. of 10%, and a repulsive elasticity at 40° C. of 80%, and an image was formed. The following evaluations were carried out.

### (Evaluation of Transferring Property)

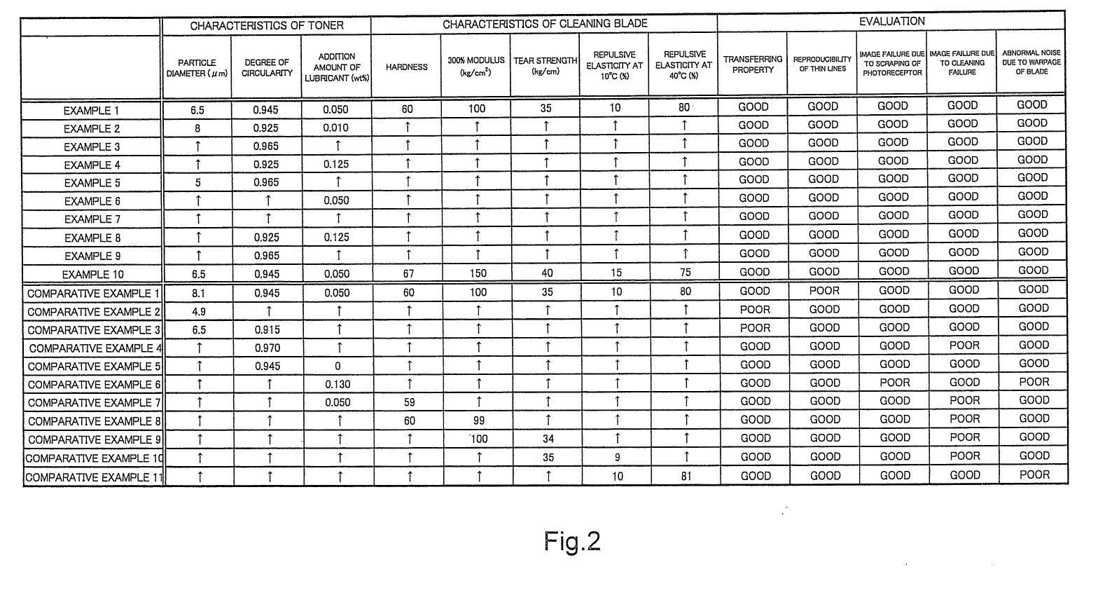

An original copy of an A4 size having a printed area ratio of 10% was duplicated to 100 sheets under two environments of the temperature and the humidity, 10° C. and 20%, and 30° C. and 85%. In the case where the weight A of the consumed toner and the weight B of the toner collected with the cleaning blade as the toner remaining untransferred satisfied B/A×100<10, it was evaluated as good, and in the case of B/A×100≧10, it was evaluated as poor. As a result, B/A×100<10 was satisfied to obtain good transferring property, as shown in FIG. 2.

### (Evaluation of Reproducibility of Thin Lines)

An original copy of an A4 size having lines with a line width of 0.05 mm formed in parallel and perpendicular to the paper conveying direction was duplicated to 100 sheets under two environments of the temperature and the humidity, 10° C. and 20%, and 30° C. and 85%. In the case where the printed lines did not suffer breakage or thickening, i.e., the line width being thickened to 0.1 mm or more, it was evaluated as good, and in the case where they occurred, it was evaluated as poor. As a result, no breakage or thickening was observed to obtain good reproducibility of thin lines, as shown in FIG. 2.

### (Evaluation of Image Failure Due to Scraping of Photoreceptor)

An original copy of an A4 size having a printed area ratio of 10% was duplicated to 100 sheets under two environments of the temperature and the humidity, 10° C. and 20%, and 30° C. and 85%. The reflectivity was measured with X-Rite 938, produced by X-Rite, Inc., and a case where it was decreased by 0.5% or more was designated as white background fogging. In the case where white background fogging, which was caused apparently by scraping (wear) of the photoreceptor, did not occur, it was evaluated as good, and in the case where the fogging occurred, it was evaluated as poor. As a result, no white background fogging was observed to obtain a favorable image, as shown in FIG. 2.

### (Evaluation of Image Failure Due to Cleaning Failure)

An original copy of an A4 size having a printed area ratio of 10% was duplicated to 100 sheets under two environments of the temperature and the humidity, 10° C. and 20%, and 30° C. and 85%. In the case where white background contamination, which was caused apparently by cleaning failure, did not occur, it was evaluated as good, and in the case where the contamination occurred, it was evaluated as poor. As a result, no white background contamination was observed to obtain a favorable image, as shown in FIG. 2.

### (Evaluation of Abnormal Noise Due to Warpage of Blade)

An original copy of an A4 size having a printed area ratio of 10% was duplicated to 100 sheets under two environments of the temperature and the humidity, 10° C. and 20%, and 30° C. and 85%. In the case where sound caused by warpage of the blade was not audible, it was evaluated as good, and in the case where it was audible, it was evaluated as poor. As a result, no sound caused by warpage of the blade was audible, as shown in FIG. 2.

### EXAMPLE 2

Toner particles having an average particle diameter of 8 μm, a degree of circularity of 0.925 and an addition amount of the metallic soap of 0.010 part by weight were formed as similar to Example 1, as shown in FIG. 2, and were mixed with the carrier as similar to Example 1, to prepare a two-component developing agent.

The developing agent thus prepared to have the formulation was put in an image forming apparatus shown in FIG. 1 using the similar cleaning blade as in Example 1 to form an image. The similar evaluations as in Example 1 revealed that good results were obtained, as shown in FIG. 2.

### EXAMPLE 3

Toner particles having an average particle diameter of 8 μm, a degree of circularity of 0.965 and an addition amount of the metallic soap of 0.010 part by weight were formed as similar to Example 1, as shown in FIG. 2, and were mixed with the carrier as similar to Example 1, to prepare a two-component developing agent.

The developing agent thus prepared to have the formulation was put in an image forming apparatus shown in FIG. 1 using the similar cleaning blade as in Example 1 to form an image. The similar evaluations as in Example 1 revealed that good results were obtained, as shown in FIG. 2.

### EXAMPLE 4

Toner particles having an average particle diameter of 8 μm, a degree of circularity of 0.925 and an addition amount of the metallic soap of 0.125 part by weight were formed as similar to Example 1, as shown in FIG. 2, and were mixed with the carrier as similar to Example 1, to prepare a two-component developing agent.

The developing agent thus prepared to have the formulation was put in an image forming apparatus shown in FIG. 1 using the similar cleaning blade as in Example 1 to form an image. The similar evaluations as in Example 1 revealed that good results were obtained, as shown in FIG. 2.

### EXAMPLE 5

Toner particles having an average particle diameter of 8 μm, a degree of circularity of 0.965 and an addition amount of the metallic soap of 0.125 part by weight were formed as similar to Example 1, as shown in FIG. 2, and were mixed with the carrier as similar to Example 1, to prepare a two-component developing agent.

The developing agent thus prepared to have the formulation was put in an image forming apparatus shown in FIG. 1 using the similar cleaning blade as in Example 1 to form an image. The similar evaluations as in Example 1 revealed that good results were obtained, as shown in FIG. 2.

### EXAMPLE 6

Toner particles having an average particle diameter of 5 μm, a degree of circularity of 0.965 and an addition amount of the metallic soap of 0.050 part by weight were formed as similar to Example 1, as shown in FIG. 2, and were mixed with the carrier as similar to Example 1, to prepare a two-component developing agent.

The developing agent thus prepared to have the formulation was put in an image forming apparatus shown in FIG. 1 using the similar cleaning blade as in Example 1 to form an image. The similar evaluations as in Example 1 revealed that good results were obtained, as shown in FIG. 2.

### EXAMPLE 7

Toner particles having an average particle diameter of 5 μm, a degree of circularity of 0.965 and an addition amount of the metallic soap of 0.010 part by weight were formed as similar to Example 1, as shown in FIG. 2, and were mixed with the carrier as similar to Example 1, to prepare a two-component developing agent.

The developing agent thus prepared to have the formulation was put in an image forming apparatus shown in FIG. 1 using the similar cleaning blade as in Example 1 to form an image. The similar evaluations as in Example 1 revealed that good results were obtained, as shown in FIG. 2.

### EXAMPLE 8

Toner particles having an average particle diameter of 5 μm, a degree of circularity of 0.925 and an addition amount of the metallic soap of 0.125 part by weight were formed as similar to Example 1, as shown in FIG. 2, and were mixed with the carrier as similar to Example 1, to prepare a two-component developing agent.

The developing agent thus prepared to have the formulation was put in an image forming apparatus shown in FIG. 1 using the similar cleaning blade as in Example 1 to form an image. The similar evaluations as in Example 1 revealed that good results were obtained, as shown in FIG. 2.

### EXAMPLE 9

Toner particles having an average particle diameter of 5 μm, a degree of circularity of 0.965 and an addition amount of the metallic soap of 0.125 part by weight were formed as similar to Example 1, as shown in FIG. 2, and were mixed with the carrier as similar to Example 1, to prepare a two-component developing agent.

The developing agent thus prepared to have the formulation was put in an image forming apparatus shown in FIG. 1 using the similar cleaning blade as in Example 1 to form an image. The similar evaluations as in Example 1 revealed that good results were obtained, as shown in FIG. 2.

### EXAMPLE 10

Toner particles having an average particle diameter of 6.5 μm, a degree of circularity of 0.945 and an addition amount of the metallic soap of 0.050 part by weight were formed as similar to Example 1, as shown in FIG. 2, and were mixed with the carrier as similar to Example 1, to prepare a two-component developing agent.

The developing agent thus prepared to have the formulation was put in an image forming apparatus shown in FIG. 1 using a cleaning blade having a blade hardness of 67, a 300% modulus of 150 kg/cm², a tear strength of 40 kg/cm, a repulsive elasticity at 10° C. of 15%, and a repulsive elasticity at 40° C. of 75% to form an image. The similar evaluations as in Example 1 revealed that good results were obtained, as shown in FIG. 2.

In Examples 1 to 10, it is understood that high cleaning property can be realized with high image quality and high transferring property obtained under suppressing deterioration in service life of the photoreceptor and the cleaning blade in the case where the toner has a particle diameter of from 5 to 8 μm and a degree of circularity of from 0.925 to 0.965 and has a lubricant added to a surface thereof in an amount of from 0.01 to 0.125 wt %, and the cleaning blade has a hardness of from 60 to 80, a 300% modulus of from 100 to 420 kg/cm², a tear strength of from 35 to 120 kg/cm, a repulsive elasticity at 10° C. of from 10 to 50%, and a repulsive elasticity at 40° C. of from 40 to 80%.

### COMPARATIVE EXAMPLE 1

Toner particles that were the same as in Example 1 except that the average particle diameter was 8.1 μm, which was larger than the specified range, were formed as similar to Example 1, as shown in FIG. 2, and were mixed with the carrier as similar to Example 1, to prepare a two-component developing agent.

The developing agent thus prepared to have the formulation was put in an image forming apparatus shown in FIG. 1 using the similar cleaning blade as in Example 1 to form an image. The similar evaluations as in Example 1 revealed that sufficient reproducibility of thin lines was not obtained, as shown in FIG. 2.

### COMPARATIVE EXAMPLE 2

Toner particles that were the same as in Example 1 except that the average particle diameter was 4.9 μm, which was smaller than the specified range, were formed as similar to Example 1, as shown in FIG. 2, and were mixed with the carrier as similar to Example 1, to prepare a two-component developing agent.

The developing agent thus prepared to have the formulation was put in an image forming apparatus shown in FIG. 1 using the similar cleaning blade as in Example 1 to form an image. The similar evaluations as in Example 1 revealed that sufficient transferring property was not obtained, as shown in FIG. 2.

### COMPARATIVE EXAMPLE 3

Toner particles that were the same as in Example 1 except that the degree of circularity was 0.915, which was smaller than the specified range, were formed as similar to Example 1, as shown in FIG. 2, and were mixed with the carrier as similar to Example 1, to prepare a two-component developing agent.

The developing agent thus prepared to have the formulation was put in an image forming apparatus shown in FIG. 1 using the similar cleaning blade as in Example 1 to form an image. The similar evaluations as in Example 1 revealed that sufficient transferring property was not obtained, as shown in FIG. 2.

### COMPARATIVE EXAMPLE 4

Toner particles that were the same as in Example 1 except that the degree of circularity was 0.970, which was larger than the specified range, were formed as similar to Example 1, as shown in FIG. 2, and were mixed with the carrier as similar to Example 1, to prepare a two-component developing agent.

The developing agent thus prepared to have the formulation was put in an image forming apparatus shown in FIG. 1 using the similar cleaning blade as in Example 1 to form an image. The similar evaluations as in Example 1 revealed that image failure due to cleaning failure occurred, as shown in FIG. 2.

### COMPARATIVE EXAMPLE 5

Toner particles that were the same as in Example 1 except that no metallic soap was added were formed as similar to Example 1, as shown in FIG. 2, and were mixed with the carrier as similar to Example 1, to prepare a two-component developing agent.

The developing agent thus prepared to have the formulation was put in an image forming apparatus shown in FIG. 1 using the similar cleaning blade as in Example 1 to form an image. The similar evaluations as in Example 1 revealed that image failure due to scraping of the photoreceptor occurred, as shown in FIG. 2.

### COMPARATIVE EXAMPLE 6

Toner particles that were the same as in Example 1 except that the addition amount of the metallic soap was 0.130 part by weight, which was larger than the specified range, were formed as similar to Example 1, as shown in FIG. 2, and were mixed with the carrier as similar to Example 1, to prepare a two-component developing agent.

The developing agent thus prepared to have the formulation was put in an image forming apparatus shown in FIG. 1 using the similar cleaning blade as in Example 1 to form an image. The similar evaluations as in Example 1 revealed that image failure due to cleaning failure and abnormal noise due to warpage of the blade occurred, as shown in FIG. 2.

### COMPARATIVE EXAMPLE 7

Toner particles that were the same as in Example 1 were formed as similar to Example 1, as shown in FIG. 2, and were mixed with the carrier as similar to Example 1, to prepare a two-component developing agent.

The developing agent thus prepared to have the formulation was put in an image forming apparatus shown in FIG. 1 using a cleaning blade that was the same as in Example 1 except that the blade hardness was 59, which was smaller than the specified range, to form an image. The similar evaluations as in Example 1 revealed that image failure due to cleaning failure occurred, as shown in FIG. 2.

### COMPARATIVE EXAMPLE 8

Toner particles that were the same as in Example 1 were formed as similar to Example 1, as shown in FIG. 2, and were mixed with the carrier as similar to Example 1, to prepare a two-component developing agent.

The developing agent thus prepared to have the formulation was put in an image forming apparatus shown in FIG. 1 using a cleaning blade that was the same as in Example 1 except that the 300% modulus was 99 kg/cm², which was smaller than the specified range, to form an image.

The similar evaluations as in Example 1 revealed that image failure due to cleaning failure occurred, as shown in FIG. 2.

### COMPARATIVE EXAMPLE 9

Toner particles that were the same as in Example 1 were formed as similar to Example 1, as shown in FIG. 2, and were mixed with the carrier as similar to Example 1, to prepare a two-component developing agent.

The developing agent thus prepared to have the formulation was put in an image forming apparatus shown in FIG. 1 using a cleaning blade that was the same as in Example 1 except that the tear strength was 34 kg/cm, which was smaller than the specified range, to form an image. The similar evaluations as in Example 1 revealed that image failure due to cleaning failure occurred, as shown in FIG. 2.

### COMPARATIVE EXAMPLE 10

Toner particles that were the same as in Example 1 were formed as similar to Example 1, as shown in FIG. 2, and were mixed with the carrier as similar to Example 1, to prepare a two-component developing agent.

The developing agent thus prepared to have the formulation was put in an image forming apparatus shown in FIG. 1 using a cleaning blade that was the same as in Example 1 except that the repulsive elasticity at 10° C. was 9%, which was smaller than the specified range, to form an image. The similar evaluations as in Example 1 revealed that image failure due to cleaning failure occurred, as shown in FIG. 2.

### COMPARATIVE EXAMPLE 11

Toner particles that were the same as in Example 1 were formed as similar to Example 1, as shown in FIG. 2, and were mixed with the carrier as similar to Example 1, to prepare a two-component developing agent.

The developing agent thus prepared to have the formulation was put in an image forming apparatus shown in FIG. 1 using a cleaning blade that was the same as in Example 1 except that the repulsive elasticity at 40° C. was 81%, which was larger than the specified range, to form an image. The similar evaluations as in Example 1 revealed that abnormal noise due to warpage of the blade occurred, as shown in FIG. 2.

In Comparative Examples 1 to 11, it is understood that high image quality, high transferring property, suppression of deterioration in service life of the photoreceptor and the cleaning blade, and high cleaning property cannot be obtained in the case where the toner does not satisfy a particle diameter of from 5 to 8 μm, a degree of circularity of from 0.925 to 0.965 and a lubricant added to a surface thereof in an amount of from 0.01 to 0.125 wt %, or the cleaning blade does not satisfy a hardness of from 60 to 80, a 300% modulus of from 100 to 420 kg/cm², a tear strength of from 35 to 120 kg/cm, a repulsive elasticity at 10° C. of from 10 to 50%, and a repulsive elasticity at 40° C. of from 40 to 80%.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
a developing device containing a toner housed therein and feeding the toner onto a photoreceptor to form a toner image, and
a cleaning blade removing the toner remaining on the photoreceptor after transferring the toner image formed on the photoreceptor to a transfer medium,
wherein the toner having a particle diameter of from 5 to 8 μm and a degree of circularity of from 0.925 to 0.965 and having a lubricant added to a surface thereof in an amount of from 0.01 to 0.125 wt %, and
the cleaning blade having a hardness of from 60 to 80, a 300% modulus of from 100 to 420 kg/cm², a tear strength of from 35 to 120 kg/cm, a repulsive elasticity at 10° C. of from 10 to 50%, and a repulsive elasticity at 40° C. of from 40 to 80%.

2. The image forming apparatus as claimed in claim 1, wherein the photoreceptor has a diameter of 50 mm or less.

3. The image forming apparatus as claimed in claim 1, wherein the lubricant is a metallic soap.

4. The image forming apparatus as claimed in claim 1, wherein the toner is mixed with a carrier and housed in the developing device.

5. The image forming apparatus as claimed in claim 1, wherein the toner contains a polyester resin.

6. The image forming apparatus as claimed in claim 1, wherein the toner contains an inorganic external additive on a surface thereof.

7. An image forming method comprising:
feeding a toner having a particle diameter of from 5 to 8 μm and a degree of circularity of from 0.925 to 0.965 and having a lubricant added to a surface thereof in an amount of from 0.01 to 0.125 wt % onto a photoreceptor to form a toner image;
transferring the toner image on the photoreceptor to a transfer medium; and
removing the toner remaining untransferred on the photoreceptor with a cleaning blade having a hardness of from 60 to 80, a 300% modulus of from 100 to 420 kg/cm² a tear strength of from 35 to 120 kg/cm, a repulsive elasticity at 10° C. of from 10 to 50%, and a repulsive elasticity at 40° C. of from 40 to 80%.

8. The image forming method as claimed in claim 7, wherein the photoreceptor has a diameter of 50 mm or less.

9. The image forming method as claimed in claim 7, wherein the lubricant is a metallic soap.

10. The image forming method as claimed in claim 7, wherein the toner is mixed with a carrier and fed onto the photoreceptor.

11. The image forming method as claimed in claim 7, wherein the toner contains a polyester resin.

12. The image forming method as claimed in claim 7, wherein the toner contains an inorganic external additive on a surface thereof.

13. A developing agent used with an image forming apparatus, comprising:
a toner having a particle diameter of from 5 to 8 μm and a degree of circularity of from 0.925 to 0.965 and having a lubricant added to a surface thereof in an amount of from 0.01 to 0.125 wt %;
wherein the image forming apparatus comprises a developing device containing a toner housed therein and feeding the toner onto a photoreceptor to form a toner image, and a cleaning blade removing the toner remaining on the photoreceptor after transferring the toner image formed on the photoreceptor to a transfer medium, and the cleaning blade having a hardness of from 60 to 80, a 300% modulus of from 100 to 420 kg/cm², a tear strength of from 35 to 120 kg/cm, a repulsive elasticity at 10° C. of from 10 to 50%, and a repulsive elasticity at 40° C. of from 40 to 80%.

14. The developing agent as claimed in claim 13, wherein the photoreceptor has a diameter of 50 mm or less.

15. The developing agent as claimed in claim 13, wherein the lubricant is a metallic soap.

16. The developing agent as claimed in claim 13, wherein the developing agent contains a carrier.

17. The developing agent as claimed in claim 13, wherein the toner contains a polyester resin.

18. The developing agent as claimed in claim 13, wherein the toner contains an inorganic external additive on a surface thereof.
